(19) United States
(12) Patent Application Publication
(10) Pub. No.: US 2016/0055496 A1
(43) Pub. Date: Feb. 25, 2016

(54) CHURN PREDICTION BASED ON EXISTING EVENT DATA

(71) Applicant: International Business Machines Corporation, Armonk, NY (US)

(72) Inventors: Itzhack Goldberg, Hadera (IL); Ofer E. Lavi, Tel-Aviv (IL); Thorsten Muehge, Budenheim (DE); Matan Y. Ninio, Tel-Aviv (IL); Erik Rueger, Ockenheim (DE); Neil Sondhi, Budapest (HU)

(21) Appl. No.: 14/467,209

(22) Filed: Aug. 25, 2014

(51) Int. Cl. G06Q 30/02; G06Q 10/06; G06N 99/00

(52) U.S. Cl. CPC G06Q 30/0202; G06N 99/005; G06Q 10/067

(57) ABSTRACT

According to one embodiment of the present invention, a method for predicting customer churn is provided. The method may comprise receiving a sequence of system events in a system log, wherein the system log is associated with a customer storage system. The method may further comprise dividing the sequence of events into a plurality of consecutive time frames. The method may further comprise assigning a state to each time frame of the plurality of consecutive time frames, wherein the state indicates a likelihood of a customer associated with the customer storage system to engage in a churn event. The method may further comprise determining whether the customer is likely to engage in the churn event based on the state of one or more time frames. The method may further comprise transmitting an alert, responsive to determining that the customer is likely to engage in the churn event.

### BACKGROUND OF THE INVENTION

The present invention relates generally to the field of customer churn prediction in storage and cloud based services, and more particularly to using existing event data in a customer's system to predict the likelihood of the customer seeking other services.

Client attrition, or client churn, refers to the loss of clients or customers. Businesses seek to minimize client churn because the cost of retaining an existing client is typically less than acquiring a new client. Clients churn for a variety of reasons, such as product/service dissatisfaction, the product fails to meet client needs, and routine product/service errors. The main tactic for preventing client churn is early detection of client dissatisfaction so that a business's customer satisfaction/sales team can address client dissatisfaction before it leads to a churn event.

Predictive analytics encompasses a variety of statistical techniques, such as modeling, machine learning, and data mining, which analyze current and historical facts to make predictions about future events. Predictive analytics can use a variety of statistical algorithms and methods to predict future events, such as machine learning algorithms. Common machine learning algorithm types include supervised learning in which a model is developed based on labeled examples (i.e., determining a model based on examples where both the input and the desired output are known), and unsupervised learning in which the model is refined using unlabeled examples (i.e., where the desired output of the model is unknown).

Cloud based and storage services commonly include monitoring capabilities for all of the systems utilized by clients. Client systems can transmit information, such as system event logs, to the central server. For example, if an error occurs on a client system, the system will automatically transmit an error report to the central server in order to allow system administrators to analyze and address the problem.

### SUMMARY

According to one embodiment of the present invention, a method for predicting customer churn is provided. The method may comprise receiving a plurality of system logs associated with a plurality of customers' storage devices, where it is known whether the customer engaged in a churn event or not. The system logs may include sequences of system events describing the customers' storage devices. The method may further include dividing the sequences of system events into a plurality of consecutive time frames. The method may further include utilizing machine learning techniques, such as expectation-maximization and feature learning, to perform supervised machine learning and determine a model for assigning one of a plurality of states to each of the consecutive time frames. The method may further include comparing the model to a second system log in which may or may not be associated with a customer who is preparing to engage in a churn event. The method may further include dividing the second system log into a plurality of consecutive time frames and comparing the plurality of consecutive time frames of the second system log with the model in order to assign a state to each of the consecutive time frames of the second system log. The method may further include determining whether the second system log is associated with a customer that is likely to engage in a churn event based, at least in part, on the states assigned to the plurality of consecutive time frames.

### BRIEF DESCRIPTION OF THE DRAWINGS

FIG. 1 is a functional block diagram illustrating a cloud storage environment, in accordance with an embodiment of the present invention;

FIG. 2 is a flowchart depicting operational steps of a churn model generation program, on a server computer within the environment of FIG. 1, in accordance with an embodiment of the present invention;

FIG. 3 is a flowchart depicting operational steps of a churn prediction program, on a server computer within the environment of FIG. 1, in accordance with an embodiment of the present invention; and

FIG. 4 depicts a block diagram of components of the server computer executing the churn prediction program, in accordance with an embodiment of the present invention.

### DETAILED DESCRIPTION

Embodiments of the present invention recognize that businesses devote substantial resources to retaining current clients. However, predicting which clients to focus retention efforts on poses a significant challenge. As used herein, “churn event” and “engaging in a churn event” refer to the act of a client or customer abandoning a service provider, such as a cloud storage provider. Clients are often unwilling to share such information openly with service providers, and by the time the business recognizes that a client is likely to churn, it is too late to take any ameliorative action and repair the relationship. Embodiments of the present invention disclose a way for businesses to use predictive analytics to analyze routinely collected data in order to predict the likelihood that a client is going to churn in the future, and alert the appropriate business team to prevent the churn event before it happens.

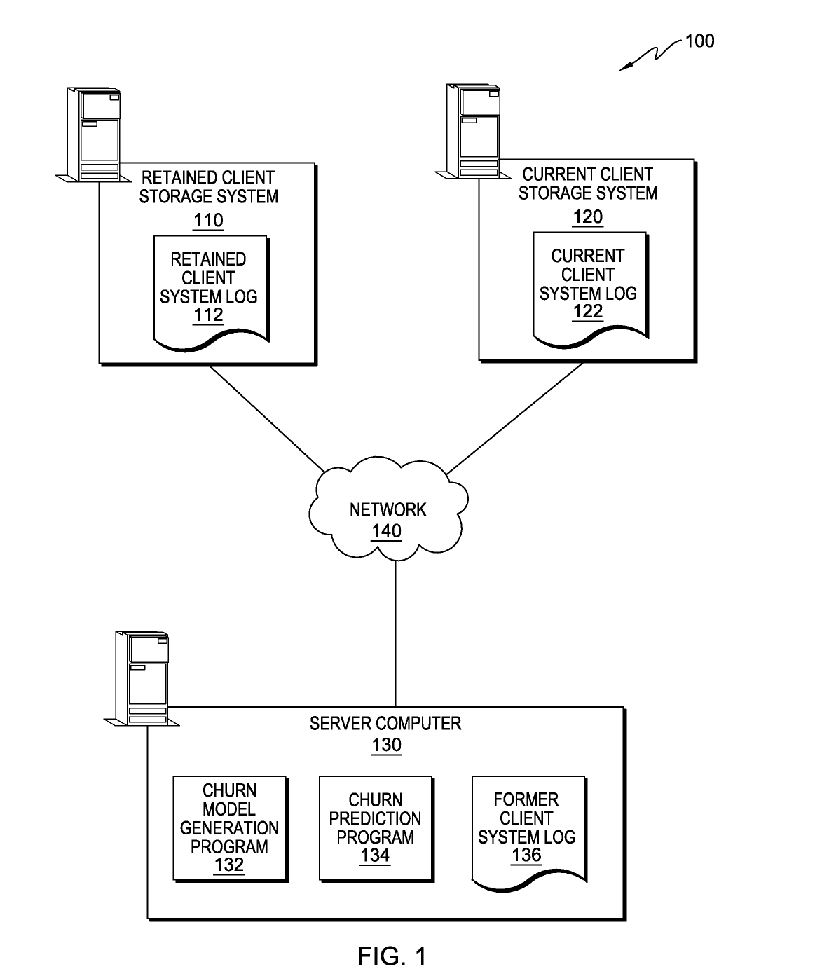

Embodiments of the present invention will now be discussed with reference to the several Figures. FIG. 1 is a functional block diagram illustrating a cloud storage environment (“environment”), generally designated 100, in accordance with an embodiment of the present invention. Environment 100 includes retained client storage system 110, current client storage system 120, and server computer 130, all interconnected over network 140.

Network 140 can be, for example, a local area network (LAN), a wide area network (WAN), such as the Internet, a dedicated short range communications network, or any combination thereof, and may include wired, wireless, fiber optic, or any other connection known in the art. In general, the communication network can be any combination of connections and protocols that will support communication between retained client storage system 110, current client storage system 120, and server computer 130.

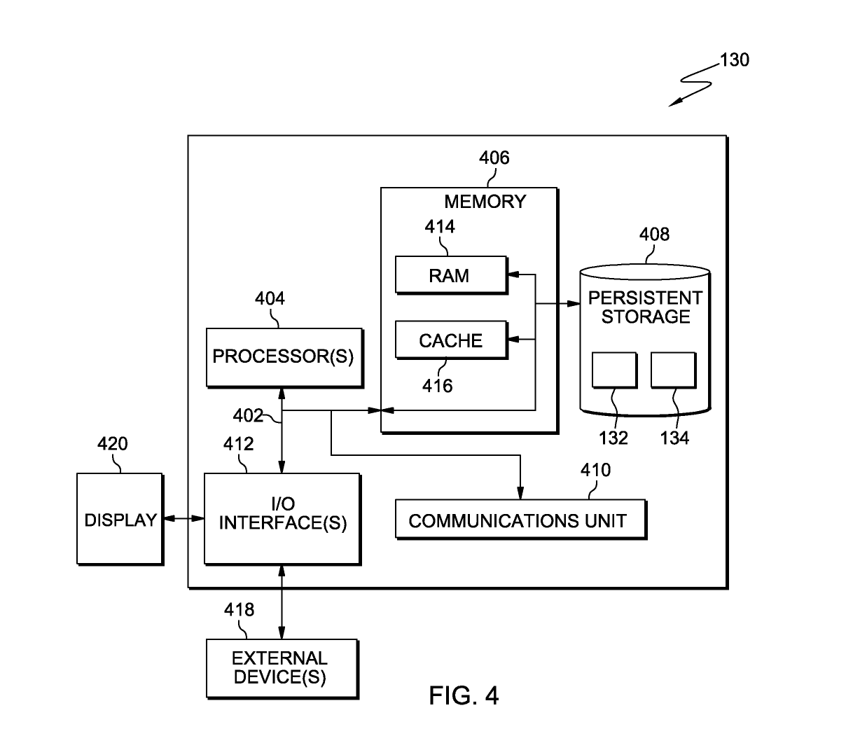

Retained client storage system 110, current client storage system 120, and server computer 130 can each be a specialized computer server, a desktop computer, a laptop computer, a tablet computer, a netbook computer, a personal computer (PC), or any other computer system known in the art. In certain embodiments, server computer 130 represents a computer system utilizing clustered computers and components that act as a single pool of seamless resources when accessed through network 140, as is common in data centers with cloud computing applications. In general, server computer 130 is representative of any programmable electronic device or combination of programmable electronic devices capable of reading machine readable program instructions and communicating with other computing devices via network 140. Server computer 130 may include internal and external hardware components, as depicted and described in further detail with respect to FIG. 4.

Retained client storage system 110 and current client storage system 120 include retained client system log 112 and current client system log 122, respectively. System logs include a timeline of system events that describe the activity of the computer generating the log. For example, Retained client storage system 110 generates a log of events, which may include information such as error reports, memory allocation, creation and deletion of logical units within the storage system, etc. Retained client system log 112 includes a timeline of events for retained client storage system 110, which is associated with a client that did not engage in a churn event. In various embodiments, retained client system log 112 may be labeled for supervised machine learning purposes as an example of a system log containing events that are not indicative of an impending client churn event. Current client system log 122 includes a timeline of events for current client storage system 120, which is associated with a current client. Embodiments of the present invention employ predictive analytics to determine whether the current client associated with current client storage system 120 is likely to engage in a churn event based on the information included in current client system log 122.

Server computer 130 includes churn model generation program 132, churn prediction program 134, and former client system log 136. Churn model generation program 132 is an application that performs a supervised analysis on labeled system logs (e.g., retained client system log 112 and former client system log 136) in order to generate a model for predicting client churn based on the types and sequence of events included in the system logs. Churn prediction program 134 is an application that performs unsupervised analysis on unlabeled system logs (e.g., current client system log 122) in order to generate a prediction for whether the client associated with the unlabeled system log is likely to engage in a churn event. Former client system log 136 is a system log containing a timeline of system events associated with a client storage system for a client that previously engaged in a churn event. Former client system log 136 can be labeled for supervised learning and analyzed by churn model generation program 132 to develop a model for predicting client churn.

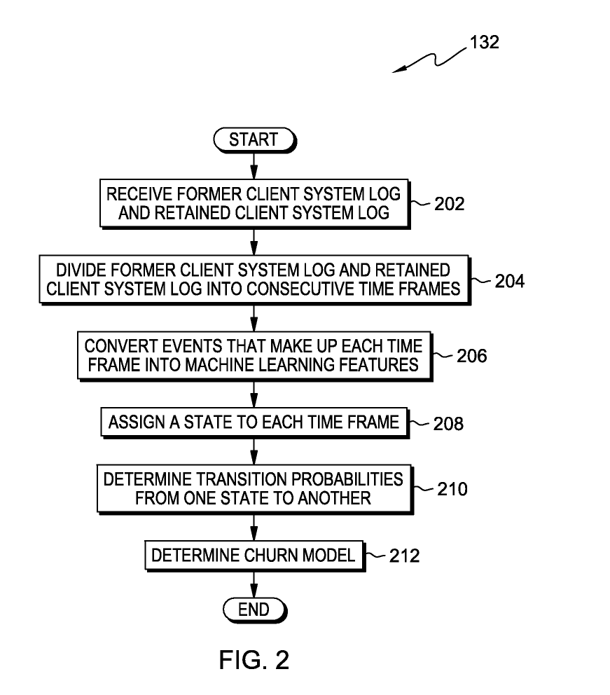

FIG. 2 is a flowchart depicting operational steps of churn model generation program 132, on server computer 130 within the environment of FIG. 1, in accordance with an exemplary embodiment of the present invention. Churn model generation program 132 conducts supervised machine learning in order to generate a model for predicting customer churn of storage clients.

In step 202, churn model generation program 132 accesses former client system log 136 and retained client system log 112. In this exemplary embodiment, churn model prediction program 132 receives retained client system log 112 from retained storage system 110 via network 140. In the embodiment of FIG. 1, former client system log 136 is included in server computer 130 for access by churn model generation program 132. In this embodiment, churn model generation program 132 has the ability to access, read, and modify the event timeline included in former client system log 136 and retained client system log 112. In other embodiments, churn model generation program 132 can receive former client system log 112 from a remote storage system.

In step 204, churn model generation program 132 divides the events included in former client system log 136 and retained client system log 112 into consecutive time frames. In this exemplary embodiment, churn model generation program divides the events included in former client system log 136 and retained client system log 112 into consecutive time frames based on the number of events in the respective log files, such that each time frame includes the same number of events. In other embodiments, churn model generation program 132 divides the events in former client system log 136 and retained client system log 112 based on the types of events, the frequency of events, the timing of events, or a combination thereof. For example, churn model generation program 132 can place a sequence of events describing system failures into a single time frame even if that time frame results in more or fewer events than other time frames.

In step 206, churn model generation program 132 converts the events that make up each time frame into machine learning features. In this exemplary embodiment, churn model generation program 132 utilizes feature learning as a technique to transform the events included in former client system log 136 and retained client system log 112 into a representative model that can be used to predict future churn events. In this exemplary embodiment, churn model generation program 132 divides the events into positive events, which represent regular usage (i.e., events that are not indicative of customer dissatisfaction), and negative events, which represent events that might be indicative of client dissatisfaction. For example, one feature may be “change in the number of logical units in a client storage system.” Other negative events may include an increasing number of system failures or errors displayed to the customer. Events such as a constant number of logical units in a client storage system indicate a positive sequence of events, while a persistently decreasing number of logical units within a client storage system indicates a negative sequence of events. Other examples of positive events include, but are not limited to, defining new hosts within a storage system, consistent number and pattern of input/output transactions processed over time, and a consistent number of users being registered with the storage system. Other examples of negative events include, but are not limited to, a decreasing number of hosts registered in a client storage system, a decrease in the amount of input/output transactions processed over time, and a decrease in the number of users registered with a client storage system.

In step 208, churn model generation program 132 assigns a state to each time frame. In this exemplary embodiment, churn model generation program 132 assigns each time frame in former client system log 136 and retained client system log 112 to one of three possible states. In this exemplary embodiment, the possible states are “normal operation,” “pre-churn operation,” and “churn preparation.” In various embodiments of the present invention, “pre-churn operation” can be defined by a sequence of failure events recorded in former client system log 136, and determined through machine learning techniques. Similarly, the “churn preparation” state can be characterized by events such as the number of logical units in the client system decreasing. In alternative embodiments, the possible states may include different or additional states depending on, for example, the method of dividing the system logs into consecutive time frames and the types of events recorded in the system logs. In the exemplary embodiment of FIG. 2, the final time frame in former client system log 136 is assigned to the “churn preparation” state because the label assigned to former client system log 136 indicates that, following the final time frame, the client associated with former client system log 136 engaged in a churn event. In this exemplary embodiment, churn model generation program 132 assigns time frames consisting of only positive events to the “normal operation” state. In certain embodiments, churn model generation program 132 assigns each time frame to a particular state such that the sequential progression of states is monotonic (i.e., over the course of multiple time frames, the sequence of states transitions smoothly from “normal operation” to “pre-churn operation” to “churn preparation”). In various embodiments, time frames can be assigned states based on the number of positive and negative events in each time frame, by comparison to other system logs in which the outcome of the events is known (i.e., whether the client engaged in a churn event or not), or some combination thereof. In some embodiments, churn model generation program 132 determines the optimal (or near optimal) state assignment together with the optimal transition probabilities from one state to another for each time frame using an expectation-maximization algorithm such as Baum-Welch.

In step 210, churn model generation program 132 determines transitional probabilities from one state to another. In the exemplary embodiment of FIG. 2, churn model generation program 132 uses an inference algorithm or an expectation-maximization algorithm to determine a probability for a given time frame, having a given state and a given sequence of events, to transition into a subsequent state. In various embodiments, churn model generation program 132 alternates between assigning states to the data and determining transition probabilities using an expectation-maximization algorithm in order to find local optimal parameters for both the state assignments and the transition probabilities.

In step 212, churn model generation program 132 determines a churn model. In this exemplary embodiment, churn model generation program 132 employs a classification algorithm to generate a model. A classification algorithm (e.g., the Viterbi algorithm) is an algorithm that uses a set of quantifiable properties (e.g., the events contained in the system logs) to generate a set of categories (i.e., states) which can be compared with other sets of properties in order to predict future events based on the present state of the other set. In one embodiment of the present invention, churn model generation program 132 uses a classification algorithm in order to generate a discriminative model for predicting client churn in storage systems. A discriminative model is a model that represents the dependence of an unobserved variable (e.g., the state of a given time frame) based on an observed variable (e.g., the sequence of events contained in the given time frame). Accordingly, using the model generated in step 212 of churn model generation program 132, a system log of a current storage client (e.g., current client storage system 120) can be compared to the model in order to predict whether the current client is likely to engage in a churn event in the future.

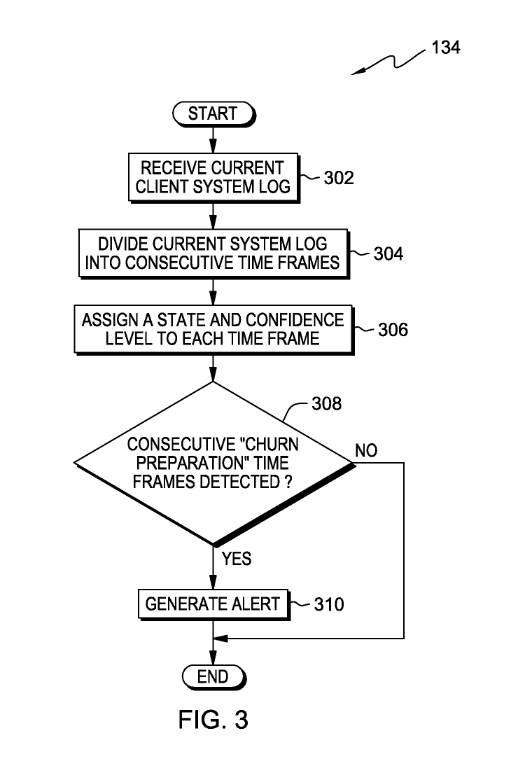

FIG. 3 is a flowchart depicting operational steps of churn prediction program 134, on server computer 130, in accordance with an exemplary embodiment of the present invention. Churn prediction program 134 represents operational steps of an unsupervised learning algorithm that uses the model generated by the supervised learning algorithm of churn model generation program 132 in order to make predictions about system logs in which the likelihood of the client to engage in a churn event is unknown.

In step 302, churn prediction program 134 accesses current client system log 122. In this exemplary embodiment, current client storage system 120 transmits current client system log 122 to computer server 130 via network 140. Churn prediction program 134 can then access, read, and modify the events contained within current client system log 122. As discussed with respect to FIG. 1, current client system log 122 includes a sequence of events for a client storage system associated with a client that may or may not be preparing for a churn event.

In step 304, churn prediction program 134 divides current system log 122 into consecutive time frames. In this exemplary embodiment, churn prediction program 134 divides the events included in current client system log 122 into consecutive time frames in the same manner as time frames were determined in churn model generation program 132. For example, if churn model generation program 132 divides the events into consecutive time frames based on the types of events included in system logs, then churn prediction program 134 divides the events in current client system log 122 based on the types of events. Accordingly, churn prediction program 134 ensures that the prediction generated with respect to current client system log 122 relies on the same analytical strategy used to generate the churn model with churn model generation program 132. According to other embodiments, churn prediction program 134 divides the events in current client system log 122 into consecutive time frames, such that the churn model generated by churn model generation program 132 can produce predictions of the current client's likelihood of engaging in a churn event to within a statistically significant certainty (e.g., 75% certain).

In step 306, churn prediction program 134 assigns a state to each time frame in current client system log 122. In this exemplary embodiment, churn prediction program 134 utilizes a classifier in order to assign a state to each time period. A classifier is an algorithm or mathematical function, implemented by a classification algorithm, which maps input data to a specific category or state. In this exemplary embodiment, churn prediction program 134 uses a classifier associated with the classification algorithm used in step 212 of churn model generation program 132 in order to generate state assignments for each time frame in current client system log 122. For example, churn prediction program 134 compares the time frames in current client system log 122 with the model generated according to the operational steps of churn model generation program 132 in order to identify similarities and determine a state assignment for each time frame that most closely matches the states outlined in the model.

In decision block 308, churn prediction program 134 determines whether consecutive time frames having a “churn preparation” state assigned to them occur in current client system log 122. In this exemplary embodiment, churn prediction program 134 compares the states of pairs of consecutive time frames in order to determine if both time frames in a pair have a “churn preparation” state. By comparing consecutive time frames, churn prediction program 134 can increase the likelihood of an accurate churn prediction by eliminating false positives in situations where the events may, for example, indicate a temporary drop in storage usage that will increase in the next time frame. Accordingly, more consecutive “churn preparation” time frames indicate a greater likelihood of a churn event in the future. In other embodiments, churn prediction program 134 compares greater numbers of consecutive time frames in order to determine if a churn event is likely to occur in the future. If churn prediction program 134 determines that no consecutive time frames are set to the “churn preparation” state (decision block 308, NO branch), then churn prediction program 134 terminates for current client system log 122. In some embodiments, churn prediction program 134 can continuously analyze current client system logs, such as current client system log 122, in order to maintain a near real-time prediction of the likelihood of a churn event. In other embodiments, churn prediction program 134 can label current client system log 122 as a retained client system log in order to perform supervised learning (e.g., using churn model generation program 132) and generate a more robust and accurate model for predicting the likelihood of a churn event.

If churn prediction program 134 determines that current client system log 122 includes consecutive time frames in the “churn preparation state (decision block 308. YES branch), then churn prediction program 134 generates an alert in step 310. In this exemplary embodiment, churn prediction program 134 generates an alert, for example, to send to a sales associate who can contact the current client associated with current client storage system 120 in order to address the client's dissatisfaction prior to churning. In various embodiments, the alert may be an email, a pop-up message, a text message, a calendar alert, or any other type of alert capable of notifying a user of a potential churn event.

FIG. 4 depicts a block diagram of components of server computer 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computer 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Churn model generation program 132 and churn prediction program 134 are stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of retained client storage system 110 and current client storage system 120. In these examples, communications unit 410 includes one or more network interface cards. Communications unit 410 may provide communications through the use of either or both physical and wireless communications links. Churn model generation program 132 and churn prediction program 134 may be downloaded to persistent storage 408 through communications unit 410.

I/O interface(s) 412 allows for input and output of data with other devices that may be connected to server computer 130. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., churn model generation program 132 and churn prediction program 134, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for predicting customer churn, the method comprising:
receiving, by one or more computer processors, a sequence of system events in a system log, wherein the system log is associated with a customer storage system;
dividing, by one or more computer processors, the sequence of events into a plurality of consecutive time frames;
assigning, by one or more computer processors, at least one state of a plurality of states to each time frame of the plurality of consecutive time frames, wherein the at least one state indicates a likelihood of a customer associated with the customer storage system to engage in a churn event;
determining, by one or more computer processors, whether the customer is likely to engage in the churn event based, at least in part, on the state of one or more time frames of the plurality of time frames; and
responsive to determining that the customer is likely to engage in the churn event, transmitting, by one or more computer processors, an alert.

2. The method of claim 1, wherein assigning the at least one state of the plurality of states to each time frame of the plurality of consecutive time frames is based, at least in part, on whether a number of logical units associated with the customer storage system has changed since a previous time frame in the plurality of consecutive time frames.

3. The method of claim 1, further comprising:
determining, by one or more computer processors, a model for assigning the at least one state of the plurality of states to each time frame of the plurality of consecutive time frame, wherein the model is determined by a machine learning algorithm.

4. The method of claim 3, wherein the machine learning algorithm is an expectation-maximization algorithm.

5. The method of claim 3, further comprising:
responsive to determining that the customer is not likely to engage in a churn event, updating, by one or more computer processors, the model based, at least in part, on the determination that the customer is not likely to engage in a churn event.

6. The method of claim 1, wherein the plurality of states includes at least one state that indicates that the customer associated with the customer storage system is preparing to engage in a churn event.

7. The method of claim 6, wherein determining whether the customer is likely to engage in a churn event comprises determining whether consecutive time frames of the plurality of time frames are assigned the at least one state that indicates that the customer associated with the customer storage system is preparing to engage in a churn event.

8. A computer program product for predicting customer churn, the computer program product comprising:
one or more computer-readable storage media and program instructions stored on the one or more computer-readable storage media, the program instructions comprising:
program instructions to receive a sequence of system events in a system log, wherein the system log is associated with a customer storage system;
program instructions to divide the sequence of events into a plurality of consecutive time frames;
program instructions to assign at least one state of a plurality of states to each time frame of the plurality of consecutive time frames, wherein the at least one state indicates a likelihood of a customer associated with the customer storage system to engage in a churn event;
program instructions to determine whether the customer is likely to engage in the churn event based, at least in part, on the state of one or more time frames of the plurality of time frames; and
program instructions to transmit an alert, responsive to determining that the customer is likely to engage in the churn event.

9. The computer program product of claim 8, wherein assigning the at least one state of the plurality of states to each time frame of the plurality of consecutive time frames is based, at least in part, on whether a number of logical units associated with the customer storage system has changed since a previous time frame in the plurality of consecutive time frames.

10. The computer program product of claim 8, further comprising:
program instructions, stored on the one or more computer readable storage media, to determine a model for assigning the at least one state of the plurality of states to each time frame of the plurality of consecutive time frame, wherein the model is determined by a machine learning algorithm.

11. The computer program product of claim 10, wherein the machine learning algorithm is an expectation-maximization algorithm.

12. The computer program product of claim 10, further comprising:
program instructions, stored on the one or more computer readable storage media, to update the model based, at least in part, on the determination that the customer is not likely to engage in a churn event, responsive to determining that the customer is not likely to engage in a churn event.

13. The computer program product of claim 8, wherein the plurality of states includes at least one state that indicates that the customer associated with the customer storage system is preparing to engage in a churn event.

14. The computer program product of claim 13, wherein the program instructions to determine whether the customer is likely to engage in a churn event comprise program instructions to determine whether consecutive time frames of the plurality of time frames are assigned the at least one state that indicates that the customer associated with the customer storage system is preparing to engage in a churn event.

15. A computer system for predicting customer churn, the computer system comprising:
one or more computer processors;
one or more computer-readable storage media;
program instructions stored on the computer-readable storage media for execution by at least one of the one or more processors, the program instructions comprising:
program instructions to receive a sequence of system events in a system log, wherein the system log is associated with a customer storage system;
program instructions to divide the sequence of events into a plurality of consecutive time frames;
program instructions to assign at least one state of a plurality of states to each time frame of the plurality of consecutive time frames, wherein the at least one state indicates a likelihood of a customer associated with the customer storage system to engage in a churn event;
program instructions to determine whether the customer is likely to engage in the churn event based, at least in part, on the state of one or more time frames of the plurality of time frames; and
program instructions to transmit an alert, responsive to determining that the customer is likely to engage in the churn event.

16. The computer system of claim 15, wherein assigning the at least one state of the plurality of states to each time frame of the plurality of consecutive time frames is based, at least in part, on whether a number of logical units associated with the customer storage system has changed since a previous time frame in the plurality of consecutive time frames.

17. The computer system of claim 15, further comprising:
program instructions, stored on the one or more computer readable storage media, to determine a model for assigning the at least one state of the plurality of states to each time frame of the plurality of consecutive time frame, wherein the model is determined by a machine learning algorithm.

18. The computer system of claim 17, wherein the machine learning algorithm is an expectation-maximization algorithm.

19. The computer system of claim 17, further comprising:
program instructions, stored on the one or more computer readable storage media, to update the model based, at least in part, on the determination that the customer is not likely to engage in a churn event, responsive to determining that the customer is not likely to engage in a churn event.

20. The computer system of claim 15, wherein the plurality of states includes at least one state that indicates that the customer associated with the customer storage system is preparing to engage in a churn event.
